(19) United States
(12) Patent Application Publication
(10) Pub. No.: US 2024/0391528 A1
(43) Pub. Date: Nov. 28, 2024

(54) System and Method for Automatic Activation of Turn Signals According to the Turning of a Steering Wheel

(71) Applicants: Marta Louise Wall, Hesperia, CA (US); Daniel Elon Wall, Hesperia, CA (US)

(72) Inventors: Marta Louise Wall, Hesperia, CA (US); Daniel Elon Wall, Hesperia, CA (US)

(21) Appl. No.: 18/384,329

(22) Filed: Oct. 26, 2023

Related U.S. Application Data
(60) Provisional application No. 63/503,911, filed on May 23, 2023.

(51) Int. Cl. B62D 15/02; B62D 11/00

(52) U.S. Cl. CPC B62D 15/0245; B62D 11/003

(57) ABSTRACT

System and method enable the automatic activation of turn signals according to the turning of a steering wheel. The method begins by detecting a current angular position of a steering wheel with an angular positioning sensor. The current angular position is relayed from the angular positioning sensor to a computing system. The left-turning signal can be activated, if the current angular position crosses over a left-turning positioning threshold. The right-turning signal can be activated, if the current angular position crosses over a right-turning positioning threshold. The left-turning signal and the right-turning signal can be activated in a hazarding light pattern, if the current angular position crosses over the left-turning positioning threshold and then back over the right-turning positioning threshold within a reckless-driving time period, or if the current angular position crosses over the right-turning positioning threshold and then back over the left-turning positioning threshold within the reckless-driving time period.

The current application claims a priority to the U.S. provisional patent application Ser. No. 63/503,911 filed on May 23, 2023.

### FIELD OF THE INVENTION

The present invention relates generally to automation systems and vehicular systems. More specifically, the present invention provides means to automatically engage the vehicle turning signals according to the maneuvering of the steering wheel.

### BACKGROUND OF THE INVENTION

Nowadays, vehicular safety is a big factor in vehicle design. Various safety features are now standard in new vehicles that help keep the passengers safe. In addition, various standard vehicle features are available to help drivers to safely drive on the road, such as vehicle turn signals. Vehicle turn signals are important tools to let other drivers know about the driver's intentions on the road, such as making a turn or changing lanes. In general, vehicle turn signals are provided on the front and rear of the vehicle so that nearby drivers can be informed of the driver's intentions. Unfortunately, many drivers fail to engage the vehicle turn signals at the appropriate time while driving. Since vehicle turn signals need to be manually engaged, many drivers do not properly engage the turn signals while driving. Further, some drivers do not engage the vehicle turn signals at all, either by choice or because of impairment issues, which can lead to unnecessary endangerment to drivers and passengers. Thus, there is a need for an automated system that engages the vehicle turn signals without manual input at the appropriate times from the driver while the vehicle is in operation.

An objective of the present invention is to provide a system and a method for automatic activation of turn signals according to the turning of a steering wheel. The present invention enables the automated activation of turn signals according to the user maneuvering of the vehicle steering wheel. Another objective of the present invention is to provide means to facilitate the engagement of the vehicle hazard lights to alert other drivers of potential reckless driving. The present invention enables the automatic activation of the vehicle hazard lights if the driver's maneuvering of the vehicle steering wheel is determined to resemble reckless driving. Another objective of the present invention is to provide a system that can be retrofitted to the vehicle or that can be integrated into the vehicle's system during manufacturing. Another objective of the present invention is to provide a system that does not obstruct the safe driving of the vehicle. Additional features and benefits of the present invention are further discussed in the sections below.

### SUMMARY OF THE INVENTION

The present invention is a system and a method for automatic activation of turn signals according to the turning of a steering wheel. The present invention enables the automated activation of the vehicle turn signals so that the vehicle turn signals can be engaged at appropriate times according to the driver's maneuvering of the vehicle steering wheel. The present invention aims to improve the safety and efficiency of signaling during vehicle maneuvers to ensure effective communication between drivers, pedestrians, and other road users. To do so, the system of the present invention is designed to monitor the vehicle steering wheel to determine the maneuvers performed by the driver. The system of the present invention can monitor the vehicle steering wheel using different technologies to determine when the vehicle steering wheel has been rotated and on what angular direction the vehicle steering wheel was rotated. According to the direction of the vehicle steering wheel's rotation, the system of the present invention activates the corresponding vehicle turning lights to alert other drivers. Further, the system of the present invention can detect reckless movement of the vehicle steering wheel that may lead to reckless driving. If reckless maneuvering of the vehicle steering wheel is detected by the system of the present invention, the vehicle hazard lights are automatically activated to alert other drivers and potentially nearby authorities.

### BRIEF DESCRIPTIONS OF THE DRAWINGS

FIG. 1 is a block diagram showing the system of the present invention.

FIG. 2 is a block diagram showing a first embodiment for the system of the present invention, wherein the system is shown integrated into the vehicle.

FIG. 3 is a block diagram showing a second embodiment for the system of the present invention, wherein the system is shown retrofitted into the vehicle.

FIG. 4 is a schematic view of a steering wheel rotated counterclockwise exceeding a left-turning angular positioning threshold for the steering wheel, wherein the left-turning angular positioning threshold is shown as θₜ and wherein the current angular position is shown as θ_{c}.

FIG. 5 is a schematic view of a steering wheel rotated clockwise exceeding a right-turning angular positioning threshold for the steering wheel, wherein the right-turning angular positioning threshold is shown as θₜ, and wherein the current angular position is shown as θ_{c}.

FIG. 6 is a flowchart showing an overall process for the method of the present invention.

FIG. 7 is a flowchart showing the subprocess of deactivating the left-turning light signal after turning the steering wheel to a normal position.

FIG. 8 is a flowchart showing the subprocess of deactivating the right-turning light signal after turning the steering wheel to a normal position.

FIG. 9 is a flowchart showing the subprocess of deactivating the left-turning light signal and the right-turning light signal after turning the steering wheel to a normal position.

FIG. 10 is a flowchart showing the subprocess of processing the sensor signals using the ECU of the vehicle.

FIG. 11 is a flowchart showing the subprocess of processing the sensor signals using a mobile processing unit.

### DETAIL DESCRIPTIONS OF THE INVENTION

All illustrations of the drawings are for the purpose of describing selected versions of the present invention and are not intended to limit the scope of the present invention.

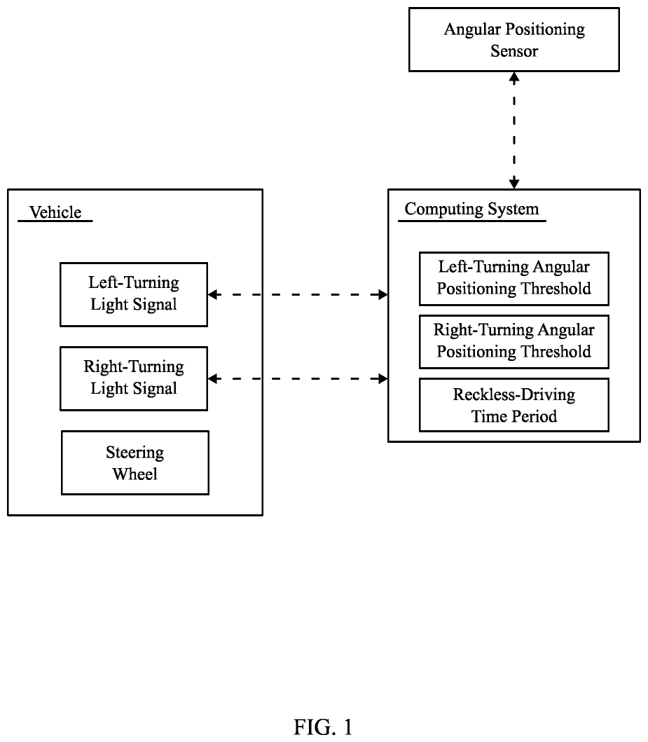

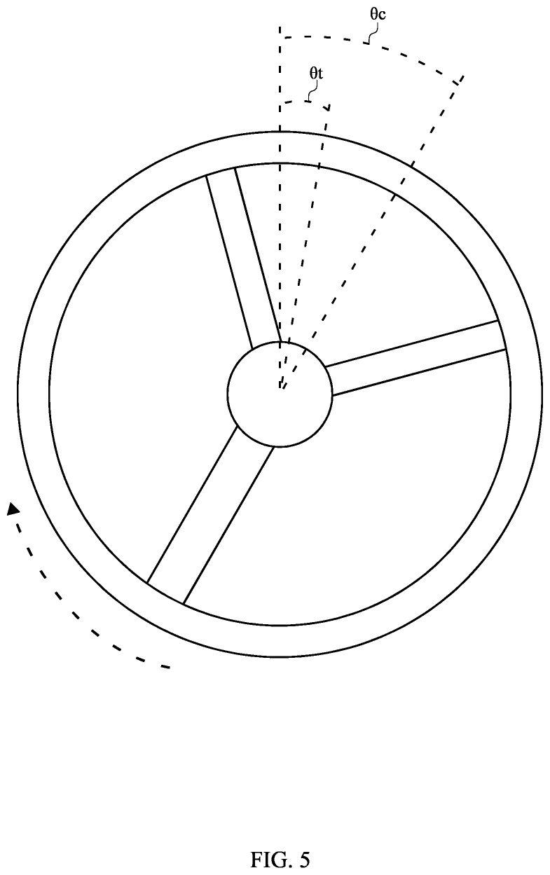

The present invention includes a system and a method for automatic activation of turn signals according to the turning of a steering wheel. The present invention ensures that the vehicle turn signals are properly engaged at the correct moments as the vehicle is driven without requiring the driver to manually engage the vehicle turn signals. As can be seen in FIGS. 1, 4, and 5, the system of the present invention includes a computing system, an angular positioning sensor, and a vehicle. The computing system preferably corresponds to at least one piece of computing hardware utilized to receive, manage, and process the sensor signals from the angular positioning sensor. The computing system also generates the activation signals necessary for the automatic activation of the vehicle turn signals. The angular positioning sensor detects and measures the rotation of the vehicle steering wheel during the vehicle operation. The angular positioning sensor also outputs a measuring reading corresponding to the rotation of the vehicle steering wheel. The vehicle is a kind of automobile (e.g., a car, a van, a truck, etc.) equipped with the computing system and the angular positioning sensor.

Further, as can be seen in FIGS. 1, 4, and 5, the vehicle includes a steering wheel, at least one left-turning light signal, and at least one right-turning light signal. The left-turning light signal and the right-turning light signal are external visual indicators that typically blink on and off and are used to signal other drivers of the vehicle's maneuvers. Further, the left-turning light signal, the right-turning light signal, and the angular positioning sensor are communicably coupled to the computing system so that a measurement reading from the angular positioning senso can be relayed to the computing system and so that the appropriate activation signals are then relayed to the left-turning light signal and/or the right-turning light signal. Furthermore, the computing system stores a left-turning angular positioning threshold for the steering wheel, a right-turning angular positioning threshold for the steering wheel, and a reckless-driving time period. The left-turning angular positioning threshold corresponds to a predetermined rotation for the steering wheel that the steering wheel must exceed in order to activate the left-turning light signal. The right-turning angular positioning threshold corresponds to a predetermined rotation for the steering wheel that the steering wheel must exceed in order to activate the right-turning light signal. Furthermore, the reckless-driving time period corresponds to a predetermined period during which the rotation of the steering wheel is monitored using the angular positioning sensor to determine reckless driving.

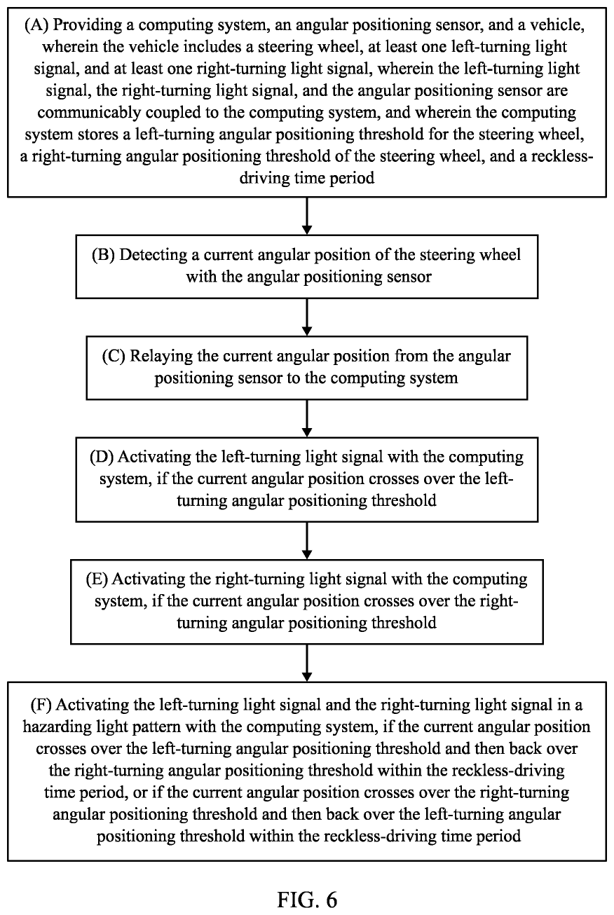

An overall process for the method of the present invention increases the safety of the drivers and the passengers by enabling the automatic activation of vehicle turning lights according to the driver's maneuvers. As can be seen in FIG. 6, the overall process begins by detecting a current angular position of the steering wheel with the angular positioning sensor (Step B). The angular positioning sensor continuously generates a sensor signal corresponding to the angular position of the steering wheel in order to keep track of the current angular position of the steering wheel. The sensor signal can be output at a predetermined interval set by the angular positioning sensor or the computing system. Next, the current angular position is relayed from the angular positioning sensor to the computing system (Step C), which allows the computing system to process the sensor signal and to determine if the current angular position matches or exceeds either the left-turning angular positioning threshold or the right-turning angular positioning threshold. According to the analysis of the current angular position, the computing system may output the activation signal that activates the appropriate vehicle turn signal whenever necessary.

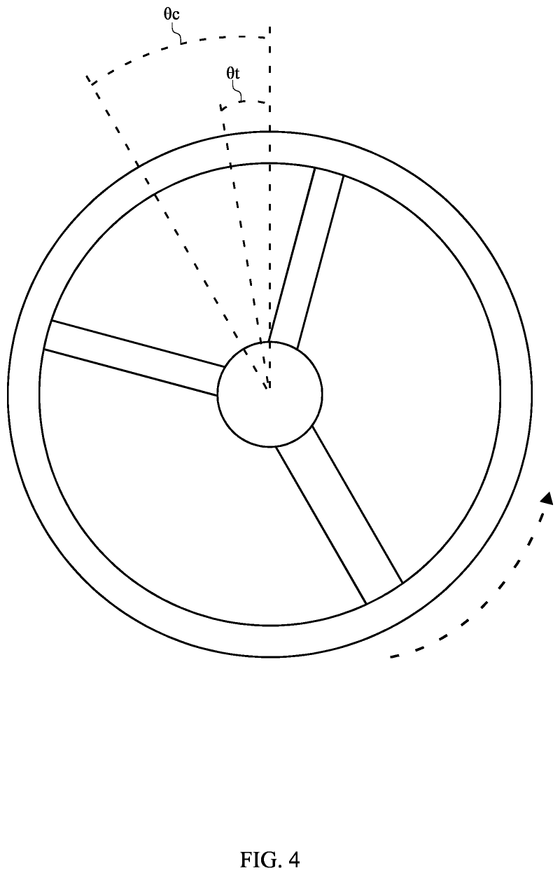

As can be seen in FIGS. 4 through 6, the overall process continues by activating the left-turning light signal with the computing system (Step D), if the current angular position crosses over the left-turning angular positioning threshold. In other words, if the current angular position of the steering wheel matches an angular positioning that corresponds to making a left-handed turn with the vehicle, then the left-turning light signal is activated. Alternatively, the right-turning light signal is activated with the computing system (Step E), if the current angular position crosses over the right-turning angular positioning threshold. In other words, if the current angular position of the steering wheel matches an angular positioning that corresponds to making a right-handed turn with the vehicle, then the right-turning light signal is activated with the computing system. Furthermore, the left-turning light signal and the right-turning light signal are activated in a hazarding light pattern with the computing system (Step F), if the current angular position crosses over the left-turning angular positioning threshold and then back over the right-turning angular positioning threshold within the reckless-driving time period, or if the current angular position crosses over the right-turning angular positioning threshold and then back over the left-turning angular positioning threshold within the reckless-driving time period. In other words, when the steering wheel is turned in a reckless manner within the reckless-driving time period (i.e., turning the steering wheel counterclockwise or clockwise in a short period of time), the left-turning light signal and the right-turning light signal are then activated in a blinking or flashy pattern to alert other drivers or nearby authorities that the driver is performing reckless maneuvers and to stay away from the vehicle.

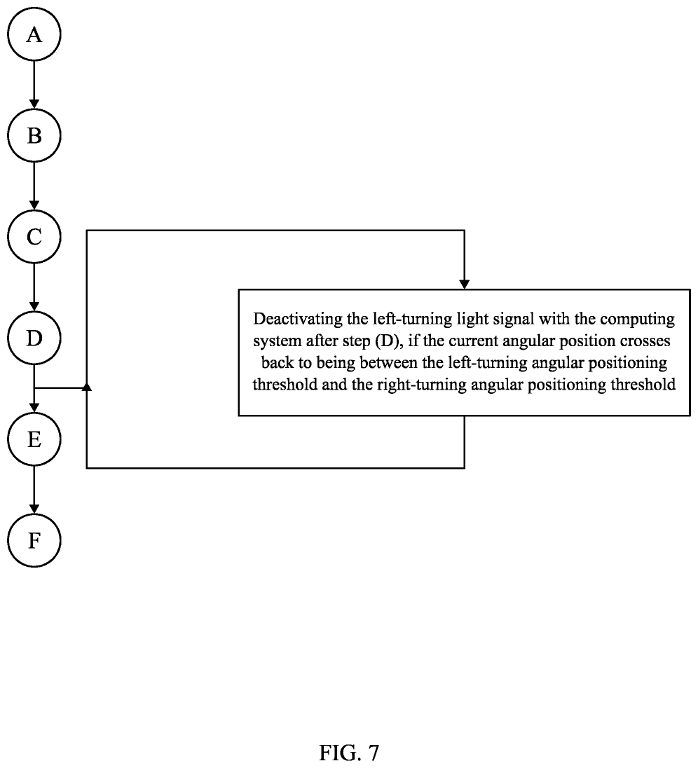

In addition to automatically activating the appropriate vehicle turn signals as the driver maneuvers the vehicle with the steering wheel, the system of the present invention can also automatically deactivate the vehicle turn signals once the driver returns to driving straight on the road. As can be seen in FIG. 7, the subprocess of deactivating the left-turning light signal after turning the steering wheel to a normal position involves the step of deactivating the left-turning light signal with the computing system after Step D, if the current angular position crosses back to being between the left-turning angular positioning threshold and the right-turning angular positioning threshold. In other words, once the driver turns the steering wheel back to an angular position where the vehicle is being driven in a straight orientation, then the left-turning light signal is automatically deactivated. Otherwise, the left-turning light signal remains active as long as the current angular position of the steering wheel crosses the left-turning angular positioning. Further, in the preferred embodiment, the left-turning angular positioning threshold preferably corresponds to an angular rotation of the steering wheel in the counterclockwise direction from the normal position of the steering wheel. For example, the left-turning angular positioning threshold can be between 3 degrees in a counterclockwise direction and 18 degrees in the counterclockwise direction. However, different ranges of angular dimensions can be utilized for the left-turning angular positioning threshold.

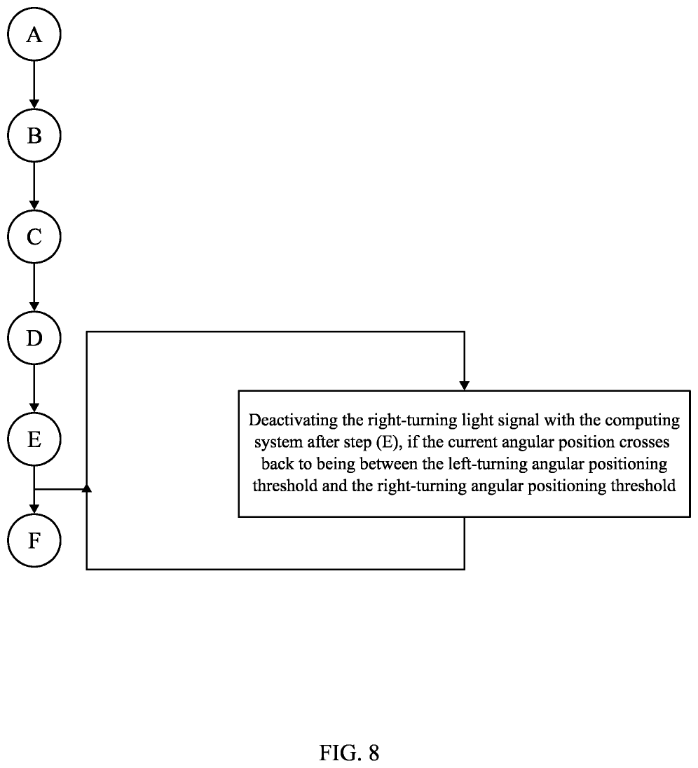

In a similar manner, the system of the present invention can also automatically deactivate the right-turning light signal once the driver returns to driving straight on the road. As can be seen in FIG. 8, the subprocess of deactivating the right-turning light signal after turning the steering wheel to a normal position involves the step of deactivating the right-turning light signal with the computing system after Step E, if the current angular position crosses back to being between the left-turning angular positioning threshold and the right-turning angular positioning threshold. In other words, once the driver turns the steering wheel back to an angular position where the vehicle is being driven in a straight orientation, then the right-turning light signal is automatically deactivated. Otherwise, the right-turning light signal remains active as long as the current angular position of the steering wheel crosses the right-turning angular positioning. Further, in the preferred embodiment, the right-turning angular positioning threshold preferably corresponds to an angular rotation of the steering wheel in the clockwise direction from the normal position of the steering wheel. For example, the right-turning angular positioning threshold can be between 3 degrees in a clockwise direction and 18 degrees in the clockwise direction. However, different ranges of angular dimensions can be utilized for the right-turning angular positioning threshold.

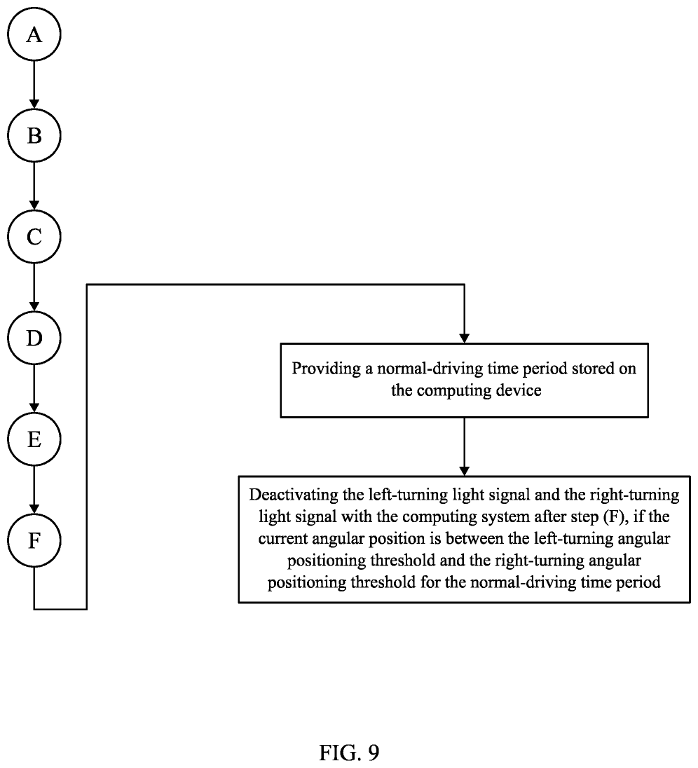

Further, the system of the present invention can also automatically deactivate the left-turning light signal and the right-turning light signal once the driver returns to driving straight on the road after driving recklessly. To do so, the system of the present invention may further include a normal-driving time period stored on the computing device. Unlike the reckless-driving time period, the normal-driving time period can correspond to a length of time during which the maneuvers of the vehicle with the steering wheel are performed in normal behavior. For example, the turning of the steering wheel by the driver in a calm and controlled manner in a predetermined time period can be considered a normal-driving time period. On the other hand, the turning of the steering wheel by the driver in a quick and hasty manner in a predetermined time period can be considered a reckless-driving time period. As can be seen in FIG. 9, the subprocess of deactivating the left-turning light signal and the right-turning light signal after turning the steering wheel to a normal position involves the step of deactivating the left-turning light signal and the right-turning light signal with the computing system after Step F, if the current angular position is between the left-turning angular positioning threshold and the right-turning angular positioning threshold for the normal-driving time period. In other words, once the driver turns the steering wheel back to an angular position where the vehicle is being driven in a straight orientation for an extended period of time, then the left-turning light signal and the right-turning light signal are automatically deactivated. Otherwise, the left-turning light signal and the right-turning light signal remain active to alert other drivers of the reckless driving. Further, the present invention can be equipped with means to alert the appropriate authorities of the reckless driving.

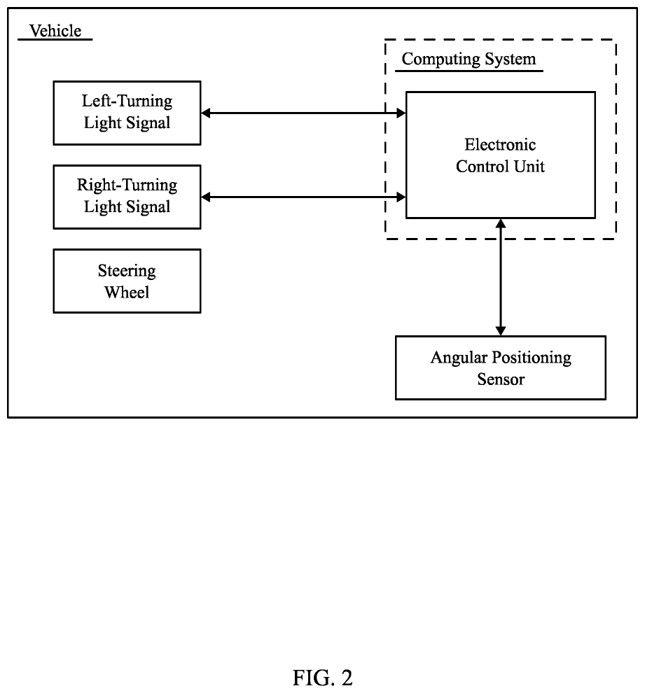

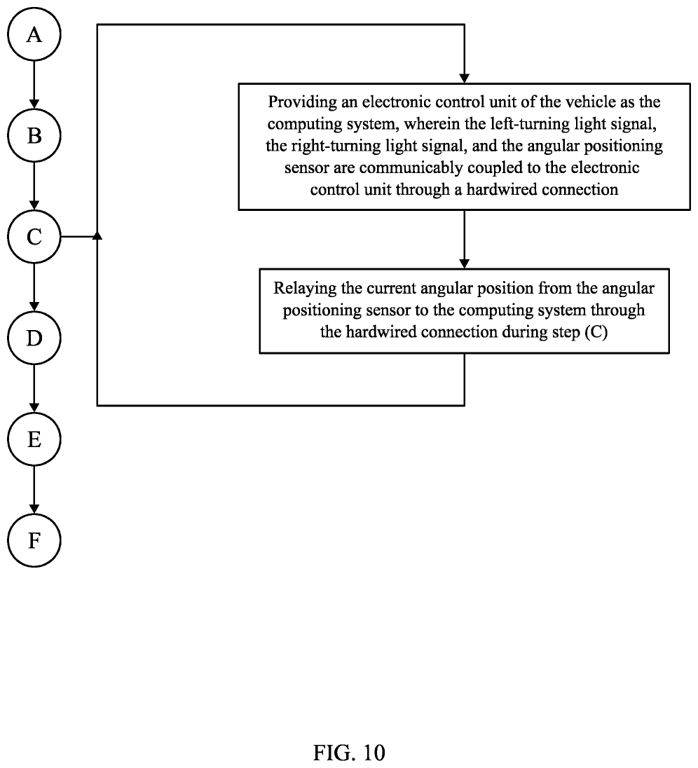

As previously discussed, the present invention can be retrofitted to an existing vehicle or can be integrated into the vehicle during the manufacturing process. As can be seen in FIGS. 2 and 10, in the embodiment where the present invention is integrated into the vehicle during the manufacturing process, an Electronic Control Unit (ECU) of the vehicle is provided as the computing system. In other words, the ECU can be designed to process the sensor signals of the angular positioning sensor. Further, the left-turning light signal, the right-turning light signal, and the angular positioning sensor are communicably coupled to ECU, which is preferably through a hardwired connection according to the vehicle's specifications or is alternatively through a wireless connection according to the vehicle's specifications. The subprocess of processing the sensor signals using the ECU involves relaying the current angular position from the angular positioning sensor to the computing system through the hardwired connection during Step C. This way, the ECU can process the sensor signals from the angular positioning sensor and activate the appropriate vehicle turn signals as the vehicle is being driven. Thus, no additional computing devices are necessary for the automatic activation of the vehicle turn signals.

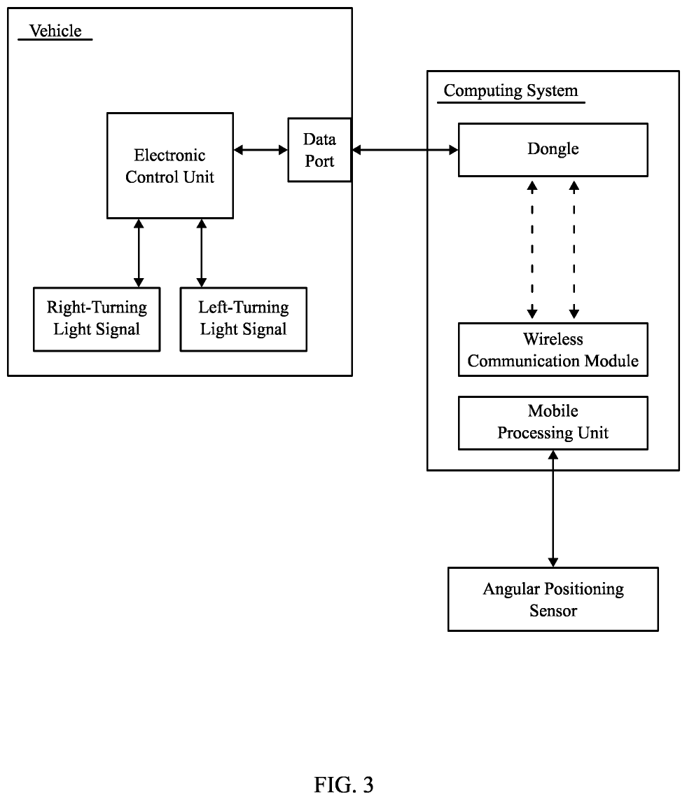

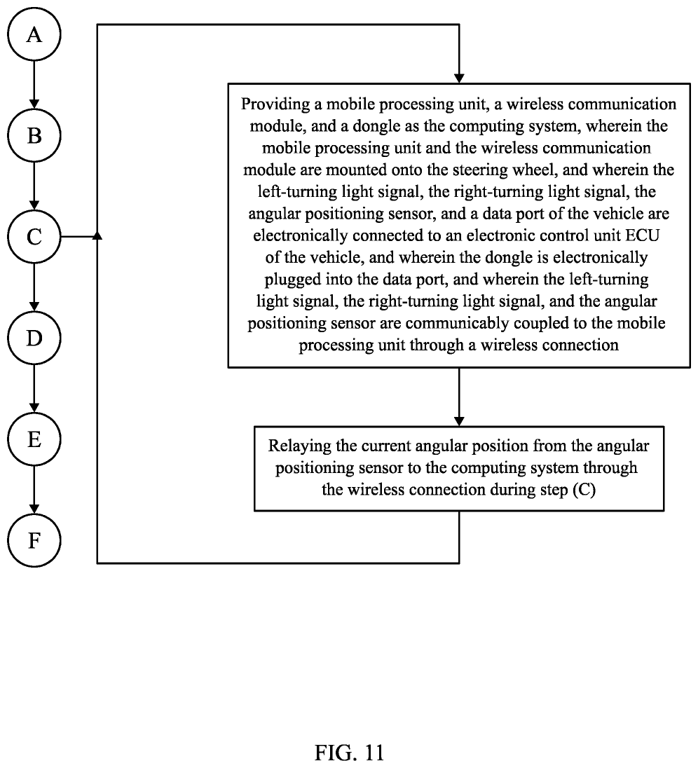

As can be seen in FIGS. 3 and 11, in the embodiment where the present invention is retrofitted into the vehicle, a mobile processing unit, a wireless communication module, and a dongle are provided as the computing system. The mobile processing unit serves as a secondary computing device that can receive, manage, and process the sensor signals relayed from the angular positioning sensor. Further, the mobile processing unit and the wireless communication module are mounted onto the steering wheel along with the angular positioning sensor in a manner that does not obstruct the maneuvering of the steering wheel. Thus, the wireless communication module and the dongle allow the mobile processing unit to wirelessly communicate with an ECU of the vehicle. In addition, the left-turning light signal, the right-turning light signal, the angular positioning sensor, and a data port of the vehicle are electronically connected to ECU. This way, activation signals received by the dongle can be transmitted to the ECU, and the appropriate vehicle turn signals are activated with the ECU. Further, the dongle is electronically plugged into the data port so that the left-turning light signal, the right-turning light signal, and the angular positioning sensor are communicably coupled to the mobile processing unit through a wireless connection between the dongle and the wireless communication module. The subprocess of processing the sensor signals using a mobile processing unit involves relaying the current angular position from the angular positioning sensor to the computing system through the wireless connection during Step C. This way, the mobile processing unit can process the sensor signals from the angular positioning sensor before relaying the activation signals through the wireless communication module, through the dongle, and to the ECU. Then, the ECU activates the appropriate vehicle turn signals as the vehicle is being driven. Thus, existing vehicles can still be equipped with the present invention to increase the safety of drivers by automatically activating vehicle turn signals according to the driver's maneuvering of the steering wheel.

Although the invention has been explained in relation to its preferred embodiment, it is to be understood that many other possible modifications and variations can be made without departing from the spirit and scope of the invention.

What is claimed is:

1. A method for automatic activation of turn signals according to the turning of a steering wheel, the method comprising the steps of:
(A) providing a computing system, an angular positioning sensor, and a vehicle, wherein the vehicle includes a steering wheel, at least one left-turning light signal, and at least one right-turning light signal, wherein the left-turning light signal, the right-turning light signal, and the angular positioning sensor are communicably coupled to the computing system, and wherein the computing system stores a left-turning angular positioning threshold for the steering wheel, a right-turning angular positioning threshold of the steering wheel, and a reckless-driving time period;
(B) detecting a current angular position of the steering wheel with the angular positioning sensor;
(C) relaying the current angular position from the angular positioning sensor to the computing system;
(D) activating the left-turning light signal with the computing system, if the current angular position crosses over the left-turning angular positioning threshold;
(E) activating the right-turning light signal with the computing system, if the current angular position crosses over the right-turning angular positioning threshold; and
(F) activating the left-turning light signal and the right-turning light signal in a hazarding light pattern with the computing system, if the current angular position crosses over the left-turning angular positioning threshold and then back over the right-turning angular positioning threshold within the reckless-driving time period, or if the current angular position crosses over the right-turning angular positioning threshold and then back over the left-turning angular positioning threshold within the reckless-driving time period.

2. The method as claimed in claim 1 comprising the step of:
deactivating the left-turning light signal with the computing system after step (D), if the current angular position crosses back to being between the left-turning angular positioning threshold and the right-turning angular positioning threshold.

3. The method as claimed in claim 1 comprising the step of:
deactivating the right-turning light signal with the computing system after step (E), if the current angular position crosses back to being between the left-turning angular positioning threshold and the right-turning angular positioning threshold.

4. The method as claimed in claim 1 comprising the steps of:
providing a normal-driving time period stored on the computing device; and
deactivating the left-turning light signal and the right-turning light signal with the computing system after step (F), if the current angular position is between the left-turning angular positioning threshold and the right-turning angular positioning threshold for the normal-driving time period.

5. The method as claimed in claim 1 comprising the steps of:
providing an electronic control unit (ECU) of the vehicle as the computing system, wherein the left-turning light signal, the right-turning light signal, and the angular positioning sensor are communicably coupled to the electronic control unit through a hardwired connection; and
relaying the current angular position from the angular positioning sensor to the computing system through the hardwired connection during step (C).

6. The method as claimed in claim 1 comprising the steps of:
providing a mobile processing unit, a wireless communication module, and a dongle as the computing system, wherein the mobile processing unit and the wireless communication module are mounted onto the steering wheel, and wherein the left-turning light signal, the right-turning light signal, the angular positioning sensor, and a data port of the vehicle are electronically connected to an electronic control unit (ECU) of the vehicle, and wherein the dongle is electronically plugged into the data port, and wherein the left-turning light signal, the right-turning light signal, and the angular positioning sensor are communicably coupled to the mobile processing unit through a wireless connection; and
relaying the current angular position from the angular positioning sensor to the computing system through the wireless connection during step (C).

7. The method as claimed in claim 1, wherein the left-turning angular positioning threshold is between 3 degrees in a counterclockwise direction and 18 degrees in the counterclockwise direction.

8. The method as claimed in claim 1, wherein the right-turning angular positioning threshold is between 3 degrees in a clockwise direction and 18 degrees in the clockwise direction.
